(19) United States
(12) Patent Application Publication
(10) Pub. No.: US 2020/0013535 A1
(43) Pub. Date: Jan. 9, 2020

(54) TRANSFORMER OIL, TRANSFORMER OIL EVALUATION METHOD, AND TRANSFORMER OIL EVALUATION APPARATUS

(71) Applicants: THE DOSHISHA, Kyoto (JP); Sakura Seiyusho Co. Ltd., Osaka (JP)

(72) Inventors: Hiroshi YAMAGUCHI, Kyoto (JP); Haruhiko YAMASAKI, Osaka (JP); Tatsuo KAWAGUCHI, Osaka (JP)

(73) Assignees: THE DOSHISHA, Kyoto (JP); Sakura Seiyusho Co. Ltd., Osaka (JP)

(21) Appl. No.: 16/493,534

(22) PCT Filed: Mar. 9, 2018
(86) PCT No.: PCT/JP2018/009188

§ 371 Date: Sep. 12, 2019

(30) Foreign Application Priority Data
Mar. 13, 2017 (JP) 2017-047617

(51) Int. Cl. H01F 27/12; C10M 107/50; C10M 101/04; H01B 3/46

(52) U.S. Cl. CPC H01F 27/12; C10M 107/50; C10N 2220/022; H01B 3/465; C10N 2230/64; C10M 101/04

(57) ABSTRACT

Provided is a transformer oil that has high environmental compatibility and is expected to be further improved in transformer cooling properties. The transformer oil is a transformer oil prepared by mixing a plant oil and a silicone oil and containing no mineral oil, in which a volume ratio of the plant oil to the silicone oil is 3:7 to 7:3 and magnetic particles (for example, temperature-sensitive magnetic particles) are dispersed.

### TECHNICAL FIELD

The present invention relates to a transformer oil, a transformer oil evaluation method, and a transformer oil evaluation apparatus.

### BACKGROUND ART

As an oil for insulating and cooling a transformer (hereinafter, transformer oil), conventionally, a mineral-derived oil (hereinafter, mineral oil) has been used, but there is a problem in that the mineral oil causes soil contamination or water contamination. For this reason, in recent years, a plant-derived oil (hereinafter, plant oil) having high environmental compatibility has been proposed to be used as a transformer oil (for example, see Patent Document 1).

### CITATION LIST

### Patent Document

Patent Document 1: JP 2016-25223 A

### SUMMARY OF THE INVENTION

### Problem to be Solved by the Invention

The problem of soil contamination or water contamination is solved by using a plant oil as the transformer oil. However, the plant oil has a high kinetic viscosity, and thus a further improvement in transformer cooling properties cannot be expected.

The present invention was made in view of the above-described circumstances, and an object thereof is to provide a transformer oil that has high environmental compatibility and is expected to be further improved in transformer cooling properties, and a method and apparatus for evaluating the transformer oil.

### Means for Solving Problem

In order to solve the above-described problems, a transformer oil according to the present invention is a transformer oil prepared by mixing a plant oil and a silicone oil and containing no mineral oil, in which

a volume ratio of the plant oil to the silicone oil is 3:7 to 7:3, and

magnetic particles are dispersed.

In the transformer oil, for example,

a volume concentration of the magnetic particles is 10 to 30%.

In the transformer oil, for example,

a surfactant is adsorbed to surfaces of the magnetic particles.

In the transformer oil, for example,

the magnetic particles are temperature-sensitive magnetic particles whose magnetization is reduced according to an increase in temperature in a normal temperature range.

In order to solve the above-described problems, a method for evaluating a transformer oil according to the present invention is

a method for evaluating a transformer oil prepared by mixing a plant oil, a silicone oil, and magnetic particles and containing no mineral oil, the method including:

a first step of heating one side of an accommodation section in which the transformer oil is accommodated and cooling the other side facing the one side to generate a temperature difference between the one side and the other side and to generate a convection flow in the transformer oil; and

a second step of calculating a Nusselt number of the transformer oil and evaluatinq the transformer oil on the basis of the Nusselt number.

In the method for evaluating a transformer oil, for example,

the magnetic particles are temperature-sensitive magnetic particles whose magnetization is reduced according to an increase in temperature in a normal temperature range, and

in the first step, a magnetic field gradient in which magnetization is reduced from the other side to the one side is generated in the transformer oil.

In addition, in order to solve the above-described problems, an apparatus for evaluating a transformer oil according to the present invention is

an apparatus for evaluating a transformer oil prepared by mixing a plant oil, a silicone oil, and magnetic particles and containing no mineral oil, the apparatus including:

a metal section;

a coil section provided in an outer circumference of the metal section;

a first accommodation section provided in an outer circumference of the coil section, the transformer oil being accommodated in the first accommodation section; and

a second accommodation section provided in an outer circumference of the first accommodation section, cooling water being accommodated in the second accommodation section, in which

when a current flows into the coil section, a temperature difference is generated between the coil section side of the first accommodation section and the second accommodation section side and a convection flow is generated in the transformer oil accommodated in the first accommodation section.

In the apparatus for evaluating a transformer oil, for example,

the magnetic particles are temperature-sensitive magnetic particles whose magnetization is reduced according to an increase in temperature in a normal temperature range.

### Effect of the Invention

According to the present invention, it is possible to provide a transformer oil that has high environmental compatibility and is expected to be further improved in transformer cooling properties, and a method and apparatus for evaluating the transformer oil.

### BRIEF DESCRIPTION OF DRAWINGS

FIG. 1 is a diagram for describing an effect of temperature-sensitive magnetic particles; and

FIG. 2 is a center cross-sectional view of a transformer oil evaluation apparatus according to an embodiment of the present invention.

### MODE(S) FOR CARRYING OUT THE INVENTION

Hereinafter, embodiments of a transformer oil, a transformer oil evaluation method, and a transformer oil evaluation apparatus according to the present invention will be described with reference to the accompanying drawings.

[Transformer Oil]

A transformer oil according to the present embodiment is prepared by mixing a plant oil and a silicone oil. In addition, the transformer oil of the present embodiment contains no mineral oil that causes soil contamination or water contamination. For this reason, the transformer oil of the present embodiment has high environmental compatibility and can be recycled.

Since the silicone oil has a smaller kinetic viscosity than the plant oil, the transformer oil of the present embodiment prepared by mixing the silicone oil with plant oil has a smaller kinetic viscosity than a conventional transformer oil composed of only a plant oil. That is, since the transformer oil of the present embodiment more easily generates a convection flow in a transformer than the conventional transformer oil and heat transfer properties are improved, an improvement in transformer cooling properties can be expected.

In the transformer oil of the present embodiment, the plant oil and the silicone oil may be contained in a the volume ratio range of 3:7 to 7:3. By adjusting the volume ratio of the plant oil to the silicone oil in a range of 3:7 to 7:3, the kinetic viscosity is adjusted so that a transformer oil having desired heat transfer properties can be provided.

In the transformer oil of the present embodiment, magnetic particles having an average particle diameter of 1 nm to 10 μm are dispersed. The volume concentration of the magnetic particles in the transformer oil is 10 to 30%. A surfactant is adsorbed to surfaces of the magnetic particles. For this reason, the magnetic particles act repulsively to each other, and dispersibility of the magnetic particles is improved.

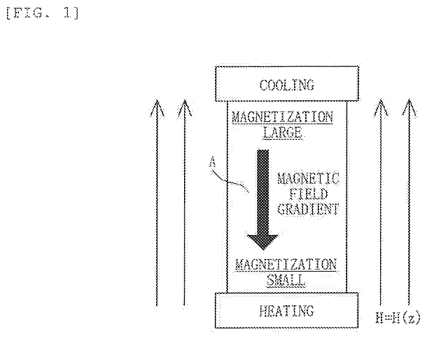

As the magnetic particles, temperature-sensitive magnetic particles (for example, manganese zinc ferrite) whose magnetization is reduced according to an increase in temperature in a normal temperature range (for example, 5° C. to 35° C.). As illustrated in FIG. 1, in a case where a magnetic fluid containing temperature-sensitive magnetic particles is accommodated in a space A in a state of applying an external magnetic field H, when the upper side of the space A is cooled and the lower side thereof is heated, the magnetization of the magnetic fluid increases at the upper side of the space A and the magnetization decreases at the lower side, so that a magnetic field gradient according to a temperature difference is generated.

That is, in a case where the temperature-sensitive magnetic particles are dispersed in the transformer oil, by the magnetic field gradient according to the temperature difference being generated, a magnetic force acts and a convection flow by a buoyancy force is promoted. As a result, heat transfer properties are further improved and a further improvement in transformer cooling properties can be expected.

[Transformer Oil Evaluation Apparatus]

Next, a transformer oil evaluation apparatus according to the present embodiment will be described.

The transformer oil evaluation apparatus according to the present embodiment is a transformer oil evaluation apparatus for evaluating a transformer oil prepared by mixing a plant oil, a silicone oil, and magnetic particles and containing no mineral oil.

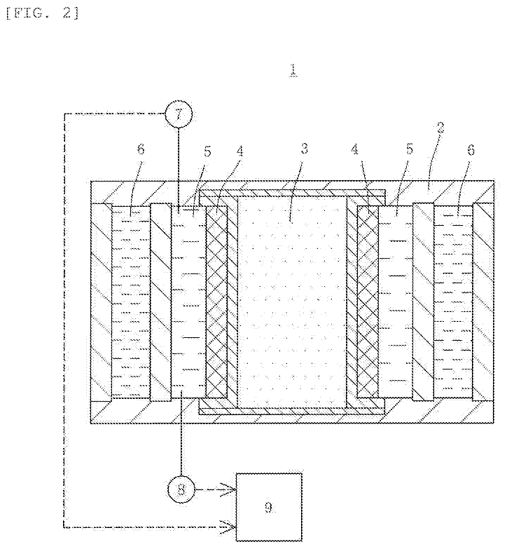

As illustrated in FIG. 2, a transformer oil evaluation apparatus 1 according to the present embodiment includes a cylindrical acrylic case 2, a cylindrical metal section 3 provided at a center of the acrylic case 2, a coil section 4 provided in an outer circumference of the metal section 3, an annular first accommodation section 5 provided in an outer circumference of the coil section 4, and an annular second accommodation section 6 provided in an outer circumference of the first accommodation section 5.

The transformer oil is accommodated in the first accommodation section 5, and cooling water is accommodated in the second accommodation section 6. In the transformer oil evaluation apparatus 1, the coil section 4 is heated by a current being allowed to flow into the coil section 4, so that a temperature difference can be generated between the coil section 4 side of the first accommodation section 5 and the second accommodation section 6 (cooling water) side and a convection flow can be generated in the transformer oil. In a case where the temperature-sensitive magnetic particles are discharged in the transformer oil, a magnetic field gradient according to the temperature difference is generated, so that the convection flow of the transformer oil is promoted.

The transformer oil evaluation apparatus 1 preferably includes a first detection unit 7 detecting a temperature of the transformer oil at the upper part of the first accommodation section 5, a second detection unit 8 detecting a temperature of the transformer oil at the lower part of the first accommodation section 5, and a calculation unit 9 configured by a computer or the like. The detection results of the first detection unit 7 and the second detection unit 8 are transmitted to the calculation unit 9. The calculation unit 9 performs various calculations (for example, calculation of a Nusselt number described later) and evaluates the transformer oil.

[Transformer Oil Evaluation Method]

Next, a transformer oil evaluation method according to the present embodiment will be described.

The transformer oil evaluation method according to the present embodiment is a transformer oil evaluation method for evaluating a transformer oil prepared by mixing a plant oil, a silicone oil, and magnetic particles and containing no mineral oil, and the method includes the following first step and second step.

In the first step, one side of an accommodation section in which the transformer oil is accommodated is heated and the other side facing the one side is cooled, so that a temperature difference is generated between the one side and the other side and a convection flow is generated in the transformer oil.

In the case of using the transformer oil evaluation apparatus 1, the coil section 4 positioned at one side of the first accommodation section 5 is heated and the second accommodation section 6 positioned at the other side of the first accommodation section 5 is cooled by cooling water. According to this, a temperature difference can be generated between the coil section 4 side of the first accommodation section 5 and the second accommodation section 6 side and a convection flow can be generated in the transformer oil. In a case where temperature-sensitive magnetic particles are dispersed in the transformer oil, a magnetic field gradient according to the temperature difference is generated, so that the convection flow of the transformer oil is promoted.

In the second step, a Nusselt number of the transformer oil is calculated and the transformer oil is evaluated on the basis of the Nusselt number by using the calculation unit 9. Preferably, a magnetic Rayleigh number is calculated together with the Nusselt number and the transformer oil is evaluated on the basis of the Nusseit number with respect to the magnetic Rayleigh number. The Nusselt number (Nu) can be calculated from the following Formula (1).

$$\begin{matrix}[ Math . 1 ] & \\ Nu = \frac{hL}{λ} = \frac{qL}{λΔ T} \\ h \text{:} Heat transfer coefficient [ W / ( {m}^{2} \cdot K ) ] \\ L \text{:} Characteristic length [ m ] \\ λ \text{:} Thermal conductivity [ W / ( m \cdot K ) ] \\ q \text{:} Heat flux [ W / {m}^{2} ] \\ Δ T \text{:} Characteristic temperature difference [ K ] & ( 1 )\end{matrix}$$

In the case of using the transformer oil evaluation apparatus 1, the calculation unit 9 can calculate a temperature difference (characteristic temperature difference ΔT) between the upper part and the lower part of the first accommodation section 5 acquired from the first detection unit 7 and the second detection unit 8 and can calculate the Nusselt number of the transformer oil in the first accommodation section 5. In this case, a characteristic length L is a height of the first accommodation section 5.

As the Nusselt number increases, a convection flow is easily generated in the transformer and an improvement in transformer cooling properties can be expected. In general, as a ratio of the silicone oil increases, the Nusselt number increases. On the other hand, as a change ratio of the Nusselt number to the magnetic Rayleigh number increases, a transportation amount of heat with a small temperature difference can increase. The change ratio decreases as the ratio of the silicone oil decreases.

Hereinbefore, the embodiments of the transformer oil, the transformer oil evaluation method, and the transformer oil evaluation apparatus according to the present invention have been described, but the present invention is not limited to the above-described embodiments.

As the magnetic particles of the present invention, arbitrary magnetic particles can be used as long as they exhibit ferromagnetic properties. Temperature-sensitive magnetic particles other than manganese zinc ferrite may be used. In addition, as long as particles are dispersed in the transformer oil, the average particle diameter of the magnetic particles can be changed or a surfactant can be omitted.

As the plant oil of the present invention, an arbitrary plant-derived oil can be used, and as the silicone oil of the present invention, an arbitrary silicone oil can be used. In addition, the transformer oil of the present invention may contain other oils or other magnetic fluids as long as the transformer oil is prepared by mixing a plant oil, a silicone oil, and magnetic particles and contains no mineral oil.

In the above-described embodiments, the transformer oil has been evaluated on the basis of the Nusselt number with respect to the magnetic Rayleigh number, but the transformer oil evaluation method of the present invention may be configured such that the transformer oil can be evaluated on the basis of at least a Nusselt number magnitude relationship.

### EXPLANATIONS OF LETTERS OR NUMERALS

1 TRANSFORMER OIL EVALUATION APPARATUS
2 ACRYLIC CASE
3 METAL SECTION
4 COIL SECTION
5 FIRST ACCOMMODATION SECTION
6 SECOND ACCOMMODATION SECTION
7 FIRST DETECTION UNIT
8 SECOND DETECTION UNIT
9 CALCULATION UNIT

1. A transformer oil prepared by mixing a plant oil and a silicone oil and comprising no mineral oil, wherein
a volume ratio of the plant oil to the silicone oil is 3:7 to 7:3, and
magnetic particles are dispersed.

2. The transformer oil according to claim 1, wherein a volume concentration of the magnetic particles is 10 to 30%.

3. The transformer oil according to claim 1, wherein a surfactant is adsorbed to surfaces of the magnetic particles.

4. The transformer oil according to claim 1, wherein the magnetic particles are temperature-sensitive magnetic particles whose magnetization is reduced according to an increase in temperature in a normal temperature range.

5. A method for evaluating a transformer oil prepared by mixing a plant oil, a silicone oil, and magnetic particles and containing no mineral oil, the method comprising:
a first step of heating one side of an accommodation section in which the transformer oil is accommodated and cooling the other side facing the one side to generate a temperature difference between the one side and the other side and to generate a convection flow in the transformer oil; and
a second step of calculating a Nusselt number of the transformer oil and evaluating the transformer oil on the basis of the Nusselt number.

6. The method for evaluating a transformer oil according to claim 5, wherein the magnetic particles are temperature-sensitive magnetic particles whose magnetization is reduced according to an increase in temperature in a normal temperature range, and
in the first step, a magnetic field gradient in which magnetization is reduced from the other side to the one side is generated in the transformer oil.

7. An apparatus for evaluating a transformer oil prepared by mixing a plant oil, a silicone oil, and magnetic particles and containing no mineral oil, the apparatus comprising:
a metal section;
a coil section provided in an outer circumference of the metal section;
a first accommodation section provided in an outer circumference of the coil section, the transformer oil being accommodated in the first accommodation section; and
a second accommodation section provided in an outer circumference of the first accommodation section, cooling water being accommodated in the second accommodation section, wherein
when a current flows into the coil section, a temperature difference is generated between the coil section side of the first accommodation section and the second accommodation section side and a convection flow is generated in the transformer oil accommodated in the first accommodation section.

8. The apparatus for evaluating a transformer oil according to claim 7, wherein the magnetic particles are temperature-sensitive magnetic particles whose magnetization is reduced according to an increase in temperature in a normal temperature range.
